(19) United States
(12) Patent Application Publication
(10) Pub. No.: US 2026/0139958 A1
(43) Pub. Date: May 21, 2026

(54) DESTINATION ARRIVAL TIME ESTIMATION METHOD AND DEVICE APPLYING THE SAME

(71) Applicant: HYUNDAI AUTOEVER CORP., Seoul (KR)

(72) Inventors: Seung Yun Jeong, Seoul (KR); Hyo Jin Lee, Seoul (KR)

(73) Assignee: HYUNDAI AUTOEVER CORP., Seoul (KR)

(21) Appl. No.: 19/384,795

(22) Filed: Nov. 10, 2025

(30) Foreign Application Priority Data
Nov. 20, 2024 (KR) 10-2024-0166068

(51) Int. Cl. G01C 21/36; G08G 1/01

(52) U.S. Cl. CPC G01C 21/3691; G01C 21/3679; G08G 1/0112; G08G 1/0133

(57) ABSTRACT

A destination arrival time estimation method includes a link-set setting step of setting a link-set for a rest area entrance/exit road to obtain driving information of vehicles entering and exiting a rest area, a vehicle driving data collection step of collecting driving data of the vehicles that is generated in units of link-sets through the global positioning system (GPS), a rest area congestion determination step of determining congestion in the rest area, based on the collected driving data of the vehicles, and providing information on the congestion to drivers, and an estimated time-of-arrival providing step of deriving an average staying time of the drivers staying in the rest area, based on the collected driving data of the vehicles, and providing a changed estimated time of arrival (ETA) to the drivers who intend to use the rest area.

### CROSS REFERENCE TO RELATED APPLICATION

This application claims the benefit of and priority to Korean Patent Application No. 10-2024-0166068, filed on Nov. 20, 2024, the entire contents of which are hereby incorporated herein by reference.

### FIELD OF TECHNOLOGY

The present disclosure relates to a destination arrival time estimation method and a destination arrival time estimation device applying the same.

### BACKGROUND

Navigation systems have been developed to guide users to select optimal paths for arriving destinations. The navigation systems primarily rely on the Global Positioning System (GPS), and are operated to identify current locations of the users and to calculate paths to the destinations through a map database. However, the navigation systems typically simply provide the paths, based on distance and road information. Consequently, there are limitations since real-time traffic conditions cannot be reflected.

In addition, traffic information such as a real-time speed and a predicted speed provided through the navigation system is generated and processed in units of road links on the geographic information system (GIS), and is utilized to derive an estimated time of arrival (ETA).

Beyond simple path guidance, recent navigation systems provide a variety of information, such as congestion and parking availability in the destinations. However, the recent navigation systems fail to specifically reflect factors indirectly related to vehicle driving, such as drivers'use of rest areas.

The discussions in this Background section are intended merely to provide background information and do not constitute an admission of prior art.

### SUMMARY

Embodiments of the present disclosure provide a destination arrival time estimation method and a destination arrival time estimation device that can solve the above-described problems.

Embodiments of the present disclosure provide a destination arrival time estimation method and a destination arrival time estimation device applying the same, that more accurately estimate an expected time of arrival at a destination by reflecting a time during which a driver stays in a highway rest area.

Embodiments of the present disclosure provide a destination arrival time estimation method and a destination arrival time estimation device applying the same, that predict a more accurate destination arrival time by estimating and reflecting a time during which a driver stays in a rest area by considering congestion in a highway rest area.

Embodiment of the present disclosure provide a destination arrival time estimation method and a destination arrival time estimation device applying the same, that predict congestion to determine whether parking is available in each rest area and/or accurately predict a time during which the drivers stay in the rest area and reflect the predicted time in the estimated time of arrival.

Embodiments of the present disclosure provide a destination arrival time estimation method and a destination arrival time estimation device that set a link-set for entrance/exit roads of a rest area and collect vehicle driving data to derive congestion for the rest area.

Embodiments of the present disclosure provide a destination arrival time estimation method and a destination arrival time estimation device that set a link-set for entrance/exit roads of a rest area, collect vehicle driving data to derive a staying time of the vehicles staying in the rest area, and provide an estimated time of arrival which reflects this staying time.

According to an embodiment of the present disclosure, a destination arrival time estimation method is provided. The destination arrival time estimation method includes a link-set setting step of setting a link-set for a rest area entrance/exit road to obtain driving information of vehicles entering and exiting a rest area, a vehicle driving data collection step of collecting driving data of the vehicles which is generated in units of link-sets through the global positioning system (GPS). The destination arrival time estimation method also includes a rest area congestion determination step of determining congestion in the rest area, based on the collected driving data of the vehicles, and providing information on the congestion to drivers. The destination arrival time estimation method additionally includes an estimated time-of-arrival providing step of deriving an average staying time of the vehicles staying in the rest area, based on the collected driving data of the vehicles, and providing a changed estimated time of arrival (ETA) to the drivers who intend to use the rest area.

An attribute of the link-set may be at least one of a main line entrance road entering the rest area from a main line, a main line exit road exiting the main line from the rest area, a connection road entrance road entering the rest area from a connection road, and a connection road exit road exiting the connection road from the rest area.

The connection road may include all roads connected to the rest area other than the main line that is a main road.

The rest area congestion determination step may include a first probe data selection step of selecting first probe data which is a processing target for determining the congestion in the rest area. The rest area congestion determination step may also include an entrance link-set probe data aggregation step of aggregating probe data matched to a past entrance link-set, in the first probe data, based on a processing time point. The rest area congestion determination step may additionally include an exit link-set probe data aggregation step of aggregating probe data that is not matched to a current exit link-set, based on the processing time point in the first probe data, and deriving the number of vehicles which do not exit the rest area, and a rest area congestion determination step of determining the congestion in the rest area by considering the number of parking spaces in the rest area.

The first probe data may include link-set attributes of a main line entrance road and the main line exit road and link-set attributes of the main line entrance road and a connection road exit road.

In the entrance link-set probe data aggregation step, the probe data matched to an entrance link-set for 60 minutes in the past may be aggregated, based on the processing time point.

In the rest area congestion determination step, the congestion may be determined as (the number of vehicles which do not exit the rest area/the number of parking spaces in the rest area)*100.

In the rest area congestion determination step, the congestion may be determined in four stages of “no information available”, “sufficient parking spaces”, a “usual state”, and a “congested state”. The “no information available” may mean a case where there is no information on the rest area.

The “sufficient parking spaces” may mean a case where the congestion is less than 10%, the “usual state” may mean a case where the congestion is 10% or more and less than 70%, and the “congested state” may mean a case where the congestion is 70% or more.

The estimated time-of-arrival providing step may include a second probe data selection step of selecting second probe data which is a processing target for providing the estimated time of arrival. The estimated time-of-arrival providing step may also include an entrance link-set probe data aggregation step of aggregating probe data matched to a past entrance link-set, based on the processing time point in the second probe data. The estimated time-of-arrival providing step may additionally include an exit link-set probe data aggregation step of aggregating probe data matched to a current exit link-set and the probe data that is not matched to the current exit link-set, based on the processing time point in the second probe data. The estimated time-of-arrival providing step may further include an estimated staying time deriving step of deriving a current estimated staying time and reflecting the current estimated staying time in the estimated time of arrival, based on rest area staying time information derived from the probe data matched to the exit link-set and the past staying time information of the vehicle which corresponds to the probe data that is not matched to the exit link-set.

The second probe data may include a link-set attribute of a main line entrance road and a main line exit road.

In the entrance link-set probe data aggregation step, probe data matched to the entrance link-set for past 60 minutes may be aggregated, based on the processing time point.

For the vehicles corresponding to the probe data matched to the entrance link-set, the current estimated staying time may be derived by calculating an average staying time for real-time rest area staying time information of the vehicles, which is derived from the probe data matched to the exit link-set, and past rest area staying time information of the vehicles, which is derived from the probe data that is not matched to the exit link-set.

The current estimated staying time may include a first estimated staying time reflected in short transit in the rest area or a second estimated staying time reflected in long transit in the rest area.

The first estimated staying time may apply staying time data corresponding to bottom 25% of an average staying time data distribution, and the second estimated staying time may apply staying time data corresponding bottom 75% of the average staying time data distribution.

The rest area staying time information may be provided to the driver in three stages of “non-transit in the rest area”, “short transit in the rest area”, and “long transit in the rest area”, in a case of the “non-transit in the rest area”. The previously provided estimated time of arrival may be maintained. In a case of the “short transit in the rest area”, the first estimated staying time may be reflected in the estimated time of arrival, and in a case of the “long transit in the rest area”, the second estimated staying time may be reflected in the estimated time of arrival.

According to another embodiment of the present disclosure, a computer-readable recording medium storing a program that causes a computer to execute the destination arrival time estimation method.

According to still another embodiment of the present disclosure, a destination arrival time estimation device is provided. The destination arrival time estimation device includes a link-set setting circuit configured to set a link set for a rest area entrance/exit road to obtain driving information of vehicles entering and exiting a rest area. The destination arrival time estimation device also includes a vehicle driving data collection circuit configured to collect driving data of the vehicles which is generated in units of link-sets through a global positioning system (GPS). The destination arrival time estimation device additionally includes a rest area congestion determination circuit configured to determine congestion in the rest area, based on the collected driving data of the vehicles, and provide information on the congestion to drivers. The destination arrival time estimation device further includes an estimated time-of-arrival providing circuit configured to derive an average staying time of the vehicles staying in the rest area, based on the collected driving data of the vehicles, and provide a changed estimated time of arrival (ETA) to the drivers who intend to use the rest area.

The rest area congestion determination circuit may include a first probe data selection unit configured to select first probe data which is a processing target for determining the congestion in the rest area. The rest area congestion determination circuit may also include an entrance link-set probe data aggregation unit configured to aggregate probe data matched to a past entrance link-set, based on a processing time point in the first probe data. The rest area congestion determination circuit may additionally include an exit link-set probe data aggregation unit configured to aggregate probe data that is not matched to a current exit link-set, in the first probe data, based on the processing time point, and derive the number of vehicles which do not exit the rest area. The rest area congestion determination circuit may further include a rest area congestion determination unit configured to determine the congestion in the rest area by considering the number of parking spaces in the rest area.

The estimated time-of-arrival providing circuit may include a second probe data selection unit that selects second probe data which is a processing target for providing the estimated time of arrival. The estimated time-of-arrival providing circuit may also include an entrance link-set probe data aggregation unit that aggregates probe data matched to a past entrance link-set, based on a processing time point in the second probe data. The estimated time-of-arrival providing circuit may additionally include an exit link-set probe data aggregation unit that aggregates probe data matched to a current exit link-set and probe data that is not matched to the current exit link-set, based on the processing time point in the second probe data. The estimated time-of-arrival providing circuit may further include an estimated staying time deriving unit that derives a current estimated staying time, based on rest area staying time information derived through the probe data matched to the exit link-set and past staying time information of the vehicles corresponding to the probe data that is not matched to the exit link-set, and reflect the current estimated staying time in the estimated time of arrival.

The current estimated staying time may include a first estimated staying time reflected in short transit in the rest area or a second estimated staying time reflected in long transit in the rest area, and the first estimated staying time applies staying time data corresponding to bottom 25% of an average staying time data distribution, and the second estimated staying time applies staying time data corresponding to bottom 75% of the average staying time data distribution.

As described above, according to embodiments of the present disclosure, a time required for parking may be predicted by collecting link driving data and trajectory data of vehicles even in a space where no link is established.

In addition, according to embodiments of the present disclosure, there may be provided the destination arrival time estimation method and the destination arrival time estimation device which may derive the congestion in the rest area by setting the link-set for the rest area entrance/exit road and collecting the driving data of the vehicles.

In addition, according to embodiments of the present disclosure, there may be provided the destination arrival time estimation method and the destination arrival time estimation device which may derive the staying time of the vehicles to provide the estimated time of arrival reflecting the staying time by setting the link-set for the rest area entrance/exit road and collecting the driving data of the vehicles to in the rest area.

Technical aspects to be achieved in the present disclosure are not limited to the above-described technical aspects. Other technical aspects not described herein should be more clearly understood by those having ordinary skill in the art to which the present disclosure pertains, from the description below.

### BRIEF DESCRIPTION OF THE DRAWINGS

In order for one having ordinary skill in the art to understand the present disclosure, various forms of the present disclosure are described by way of example with reference to the accompanying drawings, in which:

FIG. 1 is a diagram illustrating a link-set for an entrance and exit road of a rest area according to an embodiment;

FIG. 2 is a flowchart illustrating a destination arrival time estimation method according to an embodiment;

FIG. 3 is a diagram illustrating link-set attributes of a main line entrance road and a main line exit road according to an embodiment;

FIG. 4 is a diagram illustrating link-set attributes of the main line entrance road and a connection road exit road according to an embodiment;

FIG. 5 is a diagram illustrating link-set attributes of a connection road entrance road and a main line exit road according to an embodiment;

FIG. 6 is a diagram illustrating link-set attributes of the connection road entrance road and the connection road exit road according to an embodiment;

FIG. 7 is a flowchart illustrating a detailed flow of a rest area congestion determination step according to an embodiment;

FIG. 8 is a flowchart illustrating a detailed flow of an estimated time-of-arrival providing step according to an embodiment;

FIG. 9 is a diagram illustrating an example of a process of selecting and aggregating probe data according to an embodiment;

FIG. 10 is a diagram illustrating an example of a process of processing the aggregated probe data according to an embodiment;

FIG. 11 is a diagram illustrating an example of providing congestion in a rest area to drivers according to an embodiment;

FIG. 12 is a diagram illustrating an example of a state where an estimated time of arrival reflecting rest area staying time information is provided to the drivers according to an embodiment; and

FIG. 13 is a schematic diagram illustrating a destination arrival time estimation device according to an embodiment.

### DETAILED DESCRIPTION

Hereinafter, embodiments of the present disclosure are described in detail with reference to illustrative drawings. When the reference numerals are assigned to components in each drawing, it should be noted that the same reference numerals are assigned to the same components as possible, even when the same components appear in different drawings. In addition, in describing the present disclosure, where it was determined that detailed description of publicly known configurations or functions in the related art may obscure the concept of the present disclosure, the detailed description thereof has been omitted.

In addition, terms such as first, second, a, and b may be used to describe the components of embodiments of the present disclosure. These terms are only intended to distinguish one component from another component, and do not limit a feature, an order, or a sequence of the components. When it is described that one component is “connected,” “coupled,” or “joined” to another component, one component may be directly connected or joined to another component. However, it should be understood that still another component may be “connected,” “coupled,” or “joined” between the components.

When a component, controller, device, element, apparatus, circuit, unit, or the like of the present disclosure is described as having a purpose or performing an operation, function, or the like, the component, controller, device, element, apparatus, circuit, unit or the like should be considered herein as being “configured to” meet that purpose or to perform that operation or function. Each component, controller, device, element, apparatus, circuit, unit, and the like may separately embody or be included with a processor and a memory, such as a non-transitory computer readable media, as part of the apparatus.

Terms such as “ . . . circuit,” “ . . . unit,” etc. in the present specification may mean a unit that may process at least one function or operation described in this specification, and this may be implemented by hardware, software, or a combination thereof. In addition, according to embodiments described below, at least a partial configuration or function the destination arrival time estimation method and device may be implemented as a program or software, and the program or software may be stored in a computer-readable recording medium or storage medium.

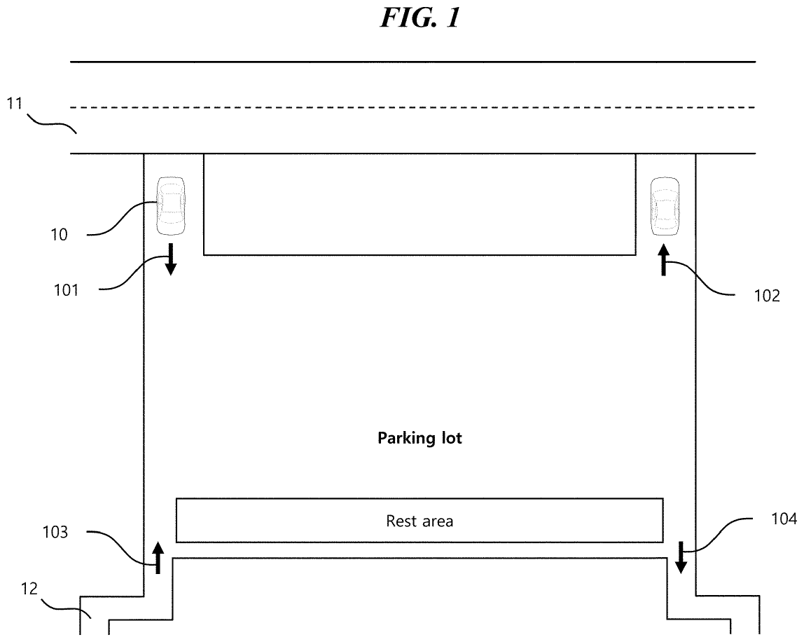

FIG. 1 is a diagram illustrating a link-set for an entrance and exit road of a rest area according to an embodiment.

Referring to FIG. 1, the rest area has an entrance road and an exit road for a vehicle 10 to enter and exit. The entrance road and the exit road are provided with a main line 11 used by main customers using the rest area and a connection road 12 connected to the rest area in addition to the main line 11.

Each entrance road and each exit road may include a main line entrance road 101 through which vehicles entering the rest area from the main line 11 travel, a main line exit road 102 through which the vehicles exiting the main line 11 from the rest area travel, a connection road entrance road 103 through which the vehicles entering the rest area from the connection road 12 travel, and a connection road exit road 104 through which the vehicles exiting the connection road 12 from the rest area travel.

A destination arrival time estimation method according to an embodiment may include a link-set setting step of setting a link-set for a rest area entrance/exit road to obtain driving information of the vehicles entering and exiting the rest area, a vehicle driving data collection step of collecting the driving data of the vehicles which is generated in units of the link-sets through a global positioning system (GPS), a rest area congestion determination step of determining congestion in the rest area, based on the collected driving data of the vehicles and providing the determined congestion to drivers, and an estimated time-of-arrival providing step of deriving an average staying time of the vehicles staying in the rest area, based on the collected driving data of the vehicles, and providing a changed estimated time of arrival (ETA) to the drivers who intend to use the rest area.

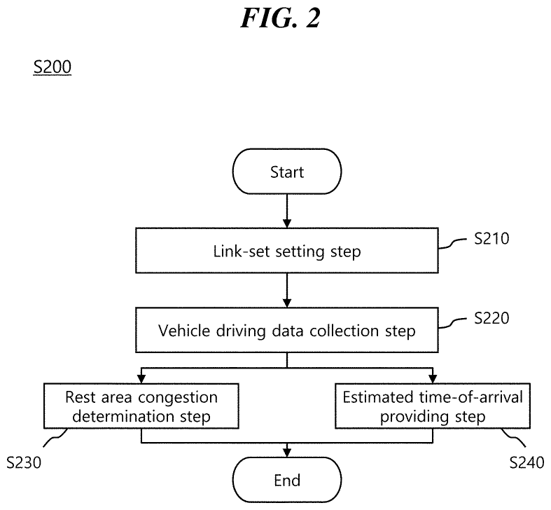

FIG. 2 is a flowchart illustrating a destination arrival time estimation method according to one embodiment.

Referring to FIG. 2, a destination arrival time estimation method S200 may include a link-set setting step or operation S210, a vehicle driving data collection step or operation S220, a rest area congestion determination step or operation S230, and an estimated time-of-arrival providing step or operation S240. In an embodiment, the rest area congestion determination step or operation S230 and the estimated time-of-arrival providing step or operation S240 may be performed in parallel.

In the link-set setting step or operation S210, a link-set may be set for the exit road or the entrance road of the rest area to obtain the driving information of the vehicles exiting or entering the rest area.

A link is a basic unit configuring a road network, and is a concept essentially used for path finding and provision of real-time traffic information. The link represents a specific zone, and is generally defined as a short zone having an independent traffic flow, such as a road or a ramp zone between intersections. These links are combined to form the road network. Through the links, navigation systems guide paths, and provide traffic information.

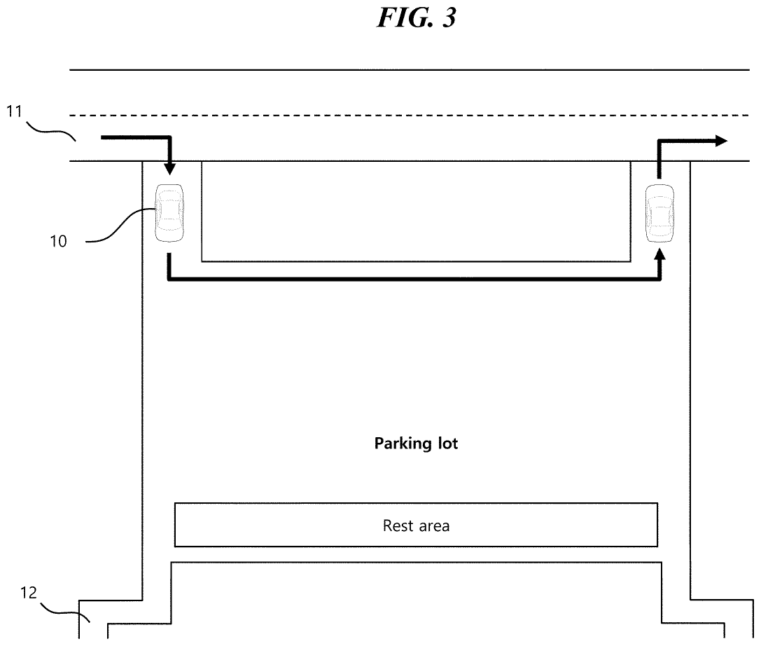

FIGS. 3-6 are diagrams illustrating link-set attributes of an entrance road and an exit road.

Referring to FIGS. 3-6, attributes of link-sets required for estimating an expected arrival time to arrive at a destination by reflecting a staying time in the rest area may be confirmed.

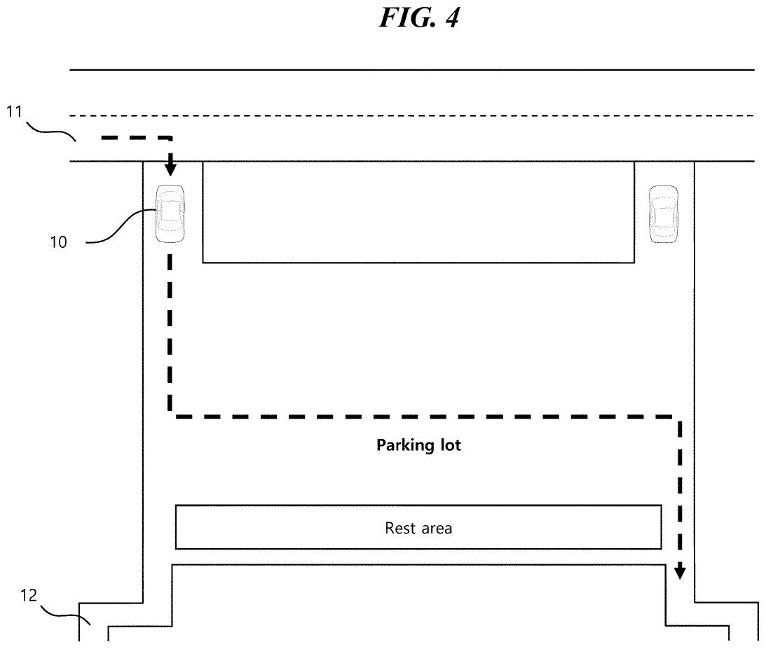

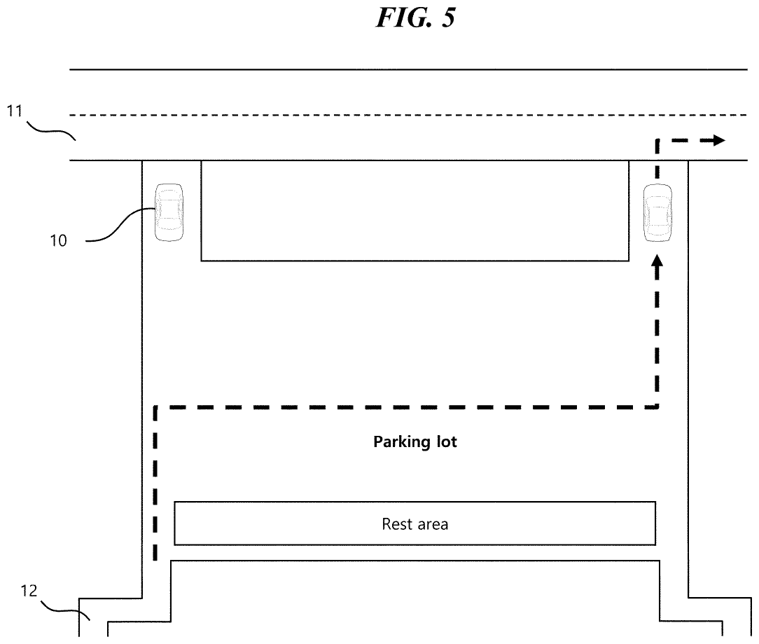

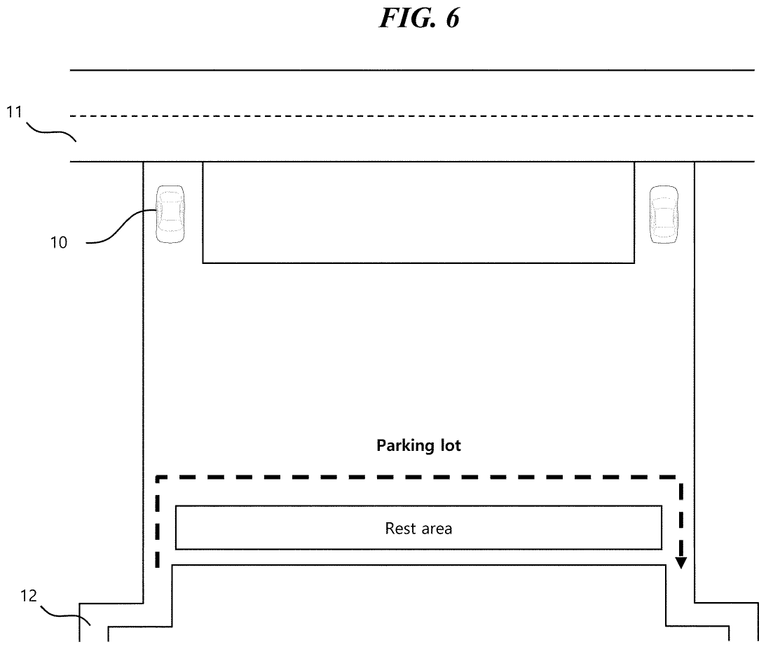

Specifically, FIG. 3 illustrates link-set attributes for a main line entrance road of a vehicle 10 entering the rest area from the main line 11 and a main line exit road of the vehicle 10 exiting the main line 11 from the rest area according to an embodiment. FIG. 4 illustrates link-set attributes for the main line entrance road of the vehicle 10 entering the rest area from the main line 11 and the connection road exit road of the vehicle 10 exiting the connection road 12 from the rest area according to an embodiment. FIG. 5 illustrates link-set attributes for the connection road entrance road of the vehicle 10 entering the rest area from the connection road 12 and the main line exit road of the vehicle 10 exiting the main line 11 from the rest area according to an embodiment. FIG. 6 illustrates link-set attributes for the connection road entrance road of the vehicle 10 entering the rest area from the connection road 12 and the connection road exit road of the vehicle 10 exiting the connection road 12 from the rest area according to an embodiment.

The link has various attributes in the navigation systems. Typical attributes include a starting point and an ending point of the link, that is, geographic coordinates where the link starts and ends. The points are generally distinguished by intersections or major junctions. A length of the link indicates a distance in a corresponding zone, and directionality indicates whether the link is one-way or two-way. In addition, the link has a designated speed limit in the corresponding zone, and the designated speed limit is used as a key factor for the navigation system to calculate the estimated time of arrival.

A road type is a criterion for distinguishing between road types, such as highways, general roads, and local roads. More specifically, the link includes traffic regulation information, such as no right turns at intersections, the presence of traffic lights, and the number of lanes. This information plays a vital role in enabling the navigation systems to provide accurate path guidance.

Based on various attributes of the link, the navigation systems find and guide paths. Path finding is a process of finding an optimal path by connecting various links required for the vehicle to travel from a departure point to a destination. A path finding algorithm calculates a shortest distance or a fastest path by using a graph theory-based algorithm, such as the Dijkstra algorithm and the A* algorithm.

The navigation systems utilize these algorithms to calculate the optimal path to the destination, based on the connection between various links. This process considers information such as an inter-link length, a speed limit, and a traffic volume, and a traveling time in each link is reflected in the calculation of the estimated time of arrival.

In addition, the navigation systems reflect real-time traffic conditions by updating traffic volumes, accident information, and the like on a link-by-link basis. This configuration allows real-time traffic data to be coupled with link information on the network, and enables the optimal paths to be provided. For example, when a specific link is blocked due to an accident or construction work or the traffic volume rapidly increases, the navigation systems may reflect this situation to suggest alternative paths through another link.

In order to provide the real-time traffic information on a link-by-link basis, it is necessary to install various sensors and data collection devices. A method for collecting traffic information of the link may be generally classified into probe data collected from stationary sensors installed on the road and probe data collected from moving vehicles.

The stationary sensors include a CCTV, a radar, a loop coil, or the like installed at specific points on the road, and these stationary sensors detect traffic volumes, speeds of vehicles, and accidents in the link, and transmit traffic data on a real-time basis.

The probe data is location data collected from GPS devices mounted on the moving vehicles, and is used to calculate an average speed and traffic conditions in the link. Based on this data, the navigation systems identify the real-time traffic conditions in the link, and update the paths.

In addition, congestion is measured on a link-by-link basis to predict road conditions. The congestion is calculated by comprehensively analyzing factors such as the number of vehicles and an average speed of vehicles located in the link. Through this calculated congestion, the navigation systems may provide users with congestion status information in each link, and may guide the users to paths which are less congested.

A function for an estimated time of arrival (ETA) in navigation systems is operated, based on the link. The function calculates a total travel time by adding up travel times for each link from the departure point to the destination. The travel time for each link is calculated by reflecting factors such as a distance of the link, a speed limit, and real-time traffic conditions.

For example, during peak traffic times, such as holidays or rush hours, the travel time in the link may be lengthened, thereby affecting the ETA. Specifically, the navigation systems analyze past traffic patterns and real-time data to predict a change in the traffic volume and the travel time during a specific time period. In this manner, accuracy in the ETA may be improved.

A link concept may be utilized in predicting a staying time and analyzing the congestion in a highway rest area. An entrance zone and an exit zone of the rest area are respectively distinguished as one link, and an average staying time is calculated by measuring a time at which a vehicle passes through an entrance link and a time at which a vehicle passes through an exit link. In this case, the navigation systems may monitor a flow of the vehicles on a link-by-link basis, and may determine the congestion in the rest area on a real-time basis.

Through this configuration, the navigation systems provide congestion information in the rest area, and guide drivers to avoid a congested rest area. For example, the navigation systems analyze information such as a vacancy rate of a parking lot and the average staying time on a link-by-link basis, and the navigation systems may assist the drivers to select a rest area in which the staying time is short. In addition to the rest area, the navigation systems may monitor traffic conditions in a road construction zone, an accident zone, or the like on a link-by-link basis, and may provide real-time traffic information to the drivers.

In order to obtain information on the congestion in the rest area, the staying time in the rest area, or the like, the link-set is set for the rest area entrance road or the rest area exit road. In this manner, the navigation systems may obtain driving information on the vehicles exiting or entering the rest area.

In the vehicle driving data collection step or operation S220, the navigation systems may collect the driving data of the vehicles 10 which is generated in units of the link-set unit through the global positioning system (GPS).

The driving data collected through the global positioning system includes information recorded when a vehicle passes through a specific link, and includes various items such as a location, a speed, a time, and a traffic volume.

The location data is collected via GPS devices, and is essential information for confirming whether the vehicle is located at any point in the link. The location data is utilized to track a travel path of the vehicle, based on a start point and an end point of the link, and serves as a basis for navigation systems to find and guide paths. Speed data indicates how fast the vehicle travels within the link, and is used to identify an average speed and a real-time speed in the zone. Through speed information collected on a link-by-link basis, the navigation systems analyze a traffic flow in the link, and calculate an expected travel time. This expected travel time serves as an important indicator for determining traffic jam or congestion.

Time data is used to record a time point at which the vehicle enters and exits the link, and to calculate a time required for the vehicle to pass through the link. Through this time data, the navigation systems may calculate an average driving time on a link-by-link basis. The time data may thus be used for calculating the estimated time of arrival (ETA). The time data is coupled with the real-time traffic information to analyze traffic patterns during a specific time period, and is also used to build a traffic prediction model. Traffic volume data is used to determine the congestion by measuring the number of vehicles located within the link. A traffic volume may be calculated, based on the number of vehicles passing through the link during the specific time period. Through this data, the navigation systems allows may analyze congested traffic conditions, and may suggest alternative paths.

Acceleration and deceleration data indicates a change in the speed of the vehicle when the vehicle travels along the link. The link in which rapid acceleration or sudden braking occurs has a possibility that traffic accidents or unexpected situations occur. The navigation systems use the acceleration and deceleration data to provide safe driving information to the drivers and to predict accident risks. Lane change and lane keeping data are useful for identifying how the vehicle travels when the vehicle approaches the intersection or enters a merge zone. High-precision navigation systems, such as autonomous vehicles, may use this lane information to provide more detailed driving guidance. The navigation systems may guide a safe lane change and safe driving by identifying whether traffic is jammed in a specific lane or whether the lanes are frequently changed.

Road condition data is information detected by sensors of the vehicle to check road surface conditions and whether obstacles are present, and includes various environmental factors such as moisture, snow, and ice on the road. This data plays a particularly important role in autonomous driving vehicles and safety driving systems. When the road is slippery, the navigation systems may recommend the driver to reduce the speed of the vehicle on the slippery road.

The probe data is a variety of driving information collected from the moving vehicle, and includes data for the speed, the acceleration, the deceleration, and the like together with GPS location information. This data plays an important role of the navigation systems in estimating real-time traffic conditions, identifying traffic congestion, and finding the paths.

Congestion and accident data is collected on a real-time basis when there is the traffic congestion or a traffic accident occurs in the link, and is used to update traffic conditions. Accident information is used in the navigation systems to suggest alternative paths or to provide road safety information. Through this data, the navigation systems find paths again on a real-time basis to avoid a link where the traffic accident occurs or there is the traffic congestion.

In the rest area congestion determination step or operation S230, the congestion in the rest area may be determined, based on the vehicle driving data collected in this way, and this information may be provided to the drivers.

Specifically, the navigation systems may select first probe data that is target data that needs to be processed to determine the congestion in the rest area. This first probe data may include link-set attributes of the main line entrance road and the main line exit road, and link-set attributes of the main line entrance road and the connection road exit road.

Next, in the entrance link-set probe data aggregation step, in the first probe data, the navigation systems may aggregate the probe data matched to a past entrance link-set, based on a processing time point. In an embodiment, the past entrance link-set means the probe data matched to the entrance link-set for 60 minutes in the past, based on the processing time point.

In the exit link-set probe data aggregation step or operation, in the first probe data, the navigation systems may derive the number of vehicles that do not exit the rest area by aggregating the probe data that is not matched to a current exit link-set, based on the processing time point.

In the rest area congestion determination step or operation, the navigation systems may derive the number of vehicles which do not exit the rest area through this process, and thereafter, may determine the congestion in the rest area by considering the number of parking spaces in the rest area. Specifically, the congestion may be determined by using Equation (1) below.

$$( the number of vehicles that do not exit the rest area / \\ the number of parking spaces in the rest area ) * 100 \qquad Equation ( 1 )$$

Based on the congestion determined through this process, the navigation systems may provide congestion information on the rest area to the drivers.

The congestion provided to the drivers may include four stages of “no information available”, “sufficient parking spaces”, a “usual state”, and a “congested state”.

A case of the “no information available” means that there is no information on the rest area, a case of the “sufficient parking spaces” means that the congestion is less than 10%. A case of the “usual state” means that the congestion is 10% or more and less than 70%. A case of the ‘“congested state” means that the congestion is 70% or more.

In the estimated time-of-arrival providing step or operation S240, the navigation systems may derive the average staying time of the vehicles staying in the rest area, based on the collected driving data of the vehicles, and may provide a changed estimated time of arrival (ETA) to the drivers who intend to use the rest area.

For example, the navigation systems may select second probe data that is target data that needs to be processed to provide the estimated time of arrival. This second probe data may include link-set attributes of the main line entrance road and the main line exit road.

Next, in the entrance link-set probe data aggregation step or operation, in the second probe data, the navigation systems may aggregate the probe data matched to the past entrance link-set, based on the processing time point. In an embodiment, the past entrance link-set means the probe data matched to the entrance link-set for 60 minutes in the past, based on the processing time point. However, the past entrance link-set is not limited thereto, and the past time standard can be changed as needed.

In the exit link-set probe data aggregation step or operation, in the second probe data, the navigation systems may aggregate the probe data matched to the current exit link-set and the probe data that is not matched to the current exit link-set, based on the processing time point.

In the estimated staying time deriving step or operation, the navigation systems may derive the current estimated staying time, and may reflect the current estimated staying time in the estimated time of arrival, based on rest area staying time information derived through the probe data matched to the exit link-set and past staying time information of the vehicle corresponding to the probe data that is not matched to the exit link-set.

In an embodiment, for the vehicles corresponding to the probe data matched to the entrance link-set, the current estimated staying time may be derived by calculating the average staying time for the real-time rest area staying time information of the vehicles which is derived through the probe data matched to the exit link-set and the past rest area staying time information of the vehicles which is derived through the probe data that is not matched to the exit link-set. The navigation systems may thus derive a more accurate staying time, based on the real-time data of the vehicles entering and exiting the rest area and the past data of the vehicles that enter but do not exit the rest area. More specifically, the navigation systems may use the average staying time information of the vehicles staying in the rest area, based on the past driving data of the vehicles that enter but do not exit the rest area.

In addition, the current estimated staying time may include a first estimated staying time reflected in short transit in the rest area, or a second estimated staying time reflected in long transit in the rest area.

In an embodiment, the first estimated staying time may apply staying time data corresponding to a lower rank of 25% of the average staying time data distribution, and the second estimated staying time may apply staying time data corresponding to a lower rank of 75% of the average staying time data distribution.

As used herein “lower rank of x %” may refer to the bottom x % of data or may refer to data that falls at or below x^{th} percentile. Thus, for example, “lower rank of 25% of the average staying time data distribution” may refer to the bottom 25% of the staying time data distribution or may refer to staying time data that falls at or below the 25^{th} percentile of the staying time data distribution. Similarly, “lower rank of 75% of the average staying time data distribution” may refer to the bottom 75% of the staying time data distribution or may refer to staying time data that falls at or below the 75^{th} percentile of the staying time data distribution.

For example, the average staying time data distribution used in the estimated staying time means the distribution of data derived based on the staying time data of the vehicle using the rest area for the past four weeks, based on the processing time point.

The estimated staying time information derived in this way may be provided to the drivers in three stages of “no transit in the rest area”, “short transit in the rest area”, and “long transit in the rest area”.

In a case of the “no transit in the rest area”, the previously provided estimated time of arrival may be maintained, in a case of the “short transit in the rest area”, the first estimated staying time may be reflected in the estimated time of arrival, and in a case of the “long transit tin the rest area”, the second estimated staying time may be reflected in the estimated time of arrival.

Roads connected to the rest area may include the main line 11 and the connection road 12. In an embodiment, the main line 11 refers to a main road used by main customers using the rest area, and may include a highway and the like. The connection road 12 may include all roads connected to the rest area other than the main line 11 which is the main road.

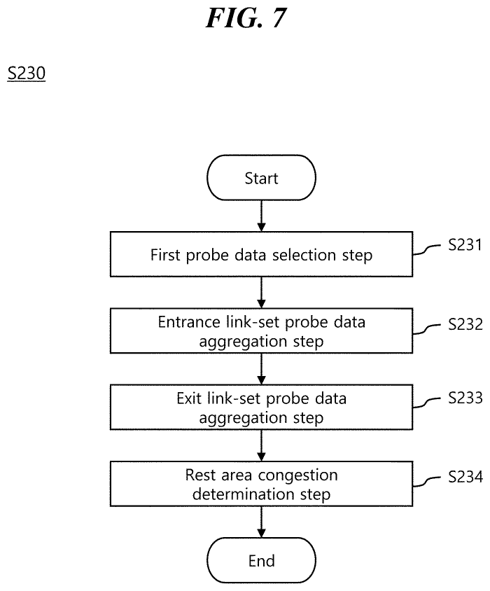

FIG. 7 is a flowchart illustrating a detailed flow of the rest area congestion determination step or operation according to an embodiment.

Referring to FIG. 7, the rest area congestion determination step or operation S230 may include a first probe data selection step or operation S231, an entrance link-set probe data aggregation step or operation S232, an exit link-set probe data aggregation step or operation S233, and a rest area congestion determination step or operation S234.

In the first probe data selection step or operation S231, the navigation systems may aggregate the first probe data that is the target data that needs to be processed to determine the congestion in the rest area. The first probe data may include link-set attributes of the main line entrance road and the main line exit road, and link-set attributes of the main line entrance road and the connection road exit road.

In the entrance link-set probe data aggregation step or operation S232, in the first probe data, the navigation systems may aggregate the probe data matched to the past entrance link-set, based on the processing time point. In an embodiment, the past entrance link-set means the probe data matched to the entrance link-set for 60 minutes in the past, based on the processing time point. However, the past entrance link-set is not limited thereto, and a past time reference may be changed when necessary.

In the exit link-set probe data aggregation step or operation S233, in the first probe data, the navigation systems may aggregate the probe data that is not matched to the current exit link-set, based on the processing time point, and may derive the number of vehicles that do not exit the rest area.

In the rest area congestion determination step or operation S234, the navigation systems may derive the number of vehicles that do not exit the rest area through this process, and thereafter, may determine the congestion in the rest area can be determined by considering the number of parking spaces in the rest area. Specifically, the congestion may be determined by using Equation (1) above.

Based on the congestion determined through this step/operation, the congestion information on the rest area may be provided to the drivers.

The congestion provided to the drivers may include four stages of the “no information available”, the “sufficient parking spaces”, the “usual state”, and the “congested state”.

A case of the “no information available’ may mean that there is no information on the rest area, a case of the “sufficient parking spaces” may mean that the congestion is less than 10%, a case of the “usual state” may mean that the congestion is 10% or more and less than 70%, and a case of the “congested state” may mean that the congestion is 70% or more.

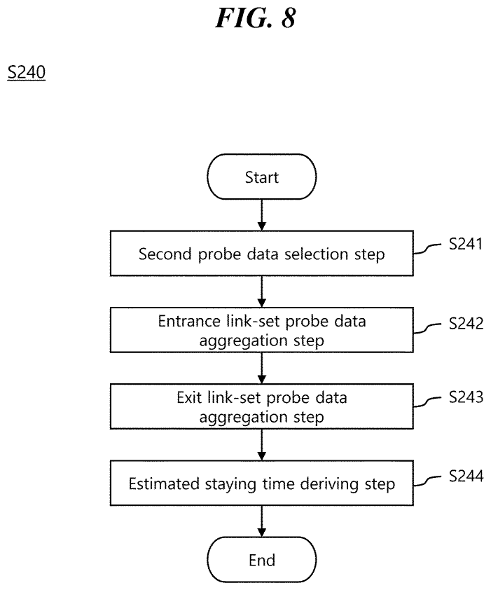

FIG. 8 is a flowchart illustrating a detailed flow of the estimated time-of-arrival providing step according to an embodiment.

Referring to FIG. 8, the estimated time-of-arrival providing step or operation S240 may include a second probe data selection step or operation S241, an entrance link-set probe data aggregation step or operation S242, an exit link-set probe data aggregation step or operation S243, and an estimated staying time deriving step or operation S244.

In the second probe data selection step or operation S241, the navigation systems may select the second probe data that is the target data that needs to be processed to provide the estimated time of arrival. This second probe data may include link-set attributes of the main line entrance road and the main line exit road.

In the entrance link-set probe data aggregation step or operation S242, in the second probe data, the navigation systems may aggregate the probe data matched to the past entrance link-set, based on the processing time point. In an embodiment, the past entrance link-set means the probe data matched to the entrance link-set for 60 minutes in the past, based on the processing time point. However, the past entrance link-set is not limited thereto, and a past time reference may be changed when necessary.

In the exit link-set probe data aggregation step or operation S243, in the second probe data, the navigation systems may aggregate the probe data matched to the current exit link-set and the probe data that is not matched to the current exit link-set, based on the processing time point.

In the estimated staying time deriving step or operation S244, the navigation systems may derive the current estimated staying time, and may reflect the current estimated staying time in the estimated time of arrival, based on rest area staying time information derived through the probe data matched to the exit link-set and past staying time information of the vehicle corresponding to the probe data that is not matched to the exit link-set.

In an embodiment, for the vehicles corresponding to the probe data matched to the entrance link-set, the current estimated staying time may be derived by calculating the average staying time for the real-time rest area staying time information of the vehicles which is derived through the probe data matched to the exit link-set and the past rest area staying time information of the vehicles which is derived through the probe data that is not matched to the exit link-set. The navigation systems may thus derive a more accurate staying time, based on the real-time data of the vehicles entering and exiting the rest area and the past data of the vehicles that enter but do not exit the rest area. More specifically, the navigation systems may use the average staying time information of the vehicles staying in the rest area, based on the past driving data of the vehicles that enter but do not exit the rest area.

In addition, the current estimated staying time may include a first estimated staying time reflected in short transit in the rest area, or a second estimated staying time reflected in long transit in the rest area.

In an embodiment, the first estimated staying time may apply staying time data corresponding to a lower rank of 25% of the average staying time data distribution, and the second estimated staying time may apply staying time data corresponding to a lower rank of 75% of the average staying time data distribution.

Specifically, the average staying time data distribution used in the estimated staying time means the distribution of data derived based on the staying time data of the vehicle using the rest area for the past four weeks, based on the processing time point.

The estimated staying time information derived in this way may be provided to the drivers in three stages of “no transit in the rest area”, “short transit in the rest area”, and “long transit in the rest area”.

In a case of the “no transit in the rest area”, the previously provided estimated time of arrival may be maintained, in a case of the “short transit in the rest area”, the first estimated staying time may be reflected in the estimated time of arrival, and in a case of the “long transit tin the rest area”, the second estimated staying time may be reflected in the estimated time of arrival.

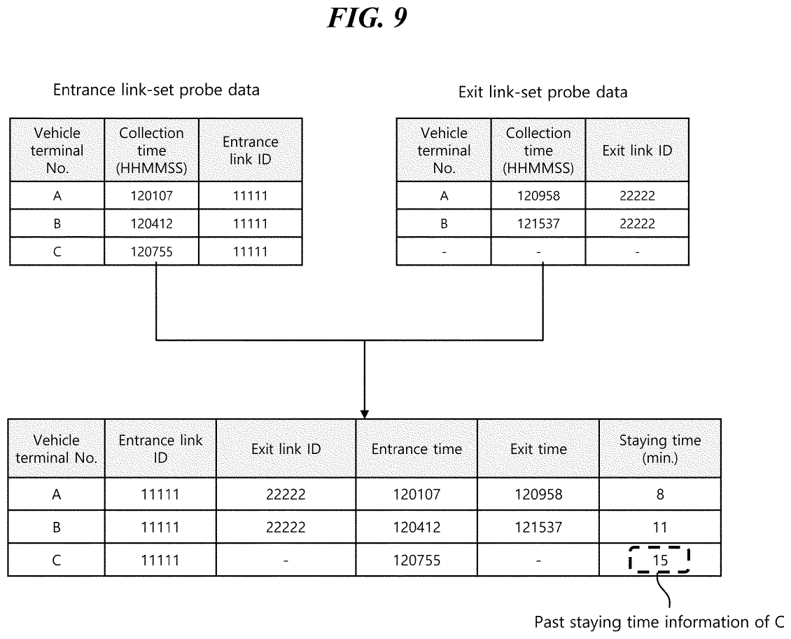

FIG. 9 is a diagram illustrating an example of a process of selecting and aggregating the probe data.

Referring to FIG. 9, the vehicles 10 have unique vehicle terminal numbers. Through the vehicle terminal numbers, the vehicles 10 may be distinguished. The navigation systems generate collection time data generated when each vehicle A, B, or C passes through a rest area entrance link ID 11111 and collection time data generated when each vehicle A or B passes through a rest area exit link ID 22222. The data generated in this way may be synthesized to derive a staying time. In a case of the vehicle C, although data indicating that the vehicle C enters the rest area is present, there is no data indicating the vehicle C exits the rest area. Therefore, a real-time staying time may not be determined, and the staying time may be derived, based on the past staying time information of the vehicle C.

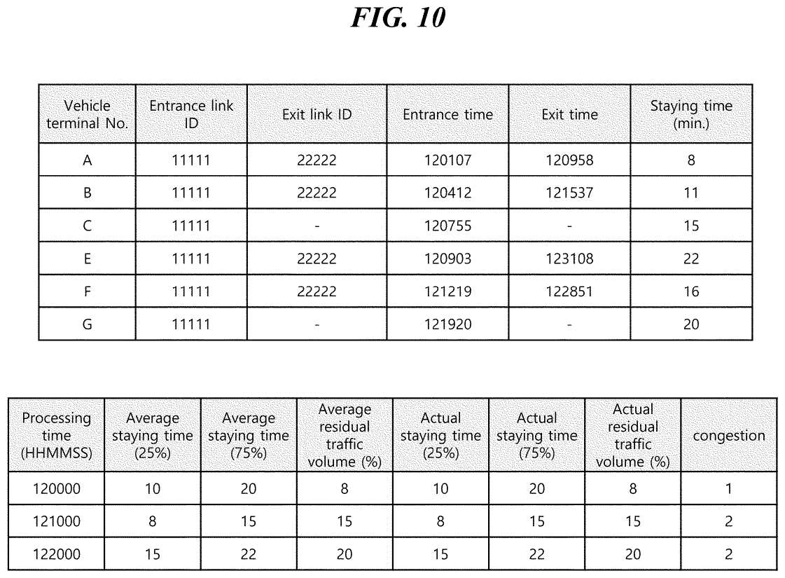

FIG. 10 is a diagram illustrating an example of a process of processing the aggregated probe data.

Referring to FIG. 10, the staying time may be derived, based on collection time data generated when each of the vehicles A, B, C, E, F, and G passes through a rest area entrance link ID 11111 and an exit link ID 22222. In an embodiment, an average staying time (25%) means the staying time corresponding to a lower rank of 25% of the staying time data distribution for the past 4 weeks, based on the processing time point. An average staying time (75%) means the staying time corresponding to a lower rank of 75% of the staying time data distribution for the past 4 weeks, based on the processing time point. An average residual traffic volume means a proportion of the vehicles staying for the past 4 weeks, based on the processing time point. A real-time staying time (25%) means the staying time corresponding to a bottom portion of 25% of the real-time staying time data distribution, based on the processing time point. A real-time staying time (75%) means the staying time corresponding to a lower rank of 75% of the real-time staying time data distribution, based on the processing time point. A real-time residual traffic volume means a proportion of vehicles currently staying in the rest are, based on the processing time point. The congestion is derived, based on the real-time residual traffic volume, and may be expressed as 1 in a case of the “sufficient parking spaces”, may be expressed as 2 in a case of the “usual state”, and may be expressed as 3 in a case of the “congested state”.

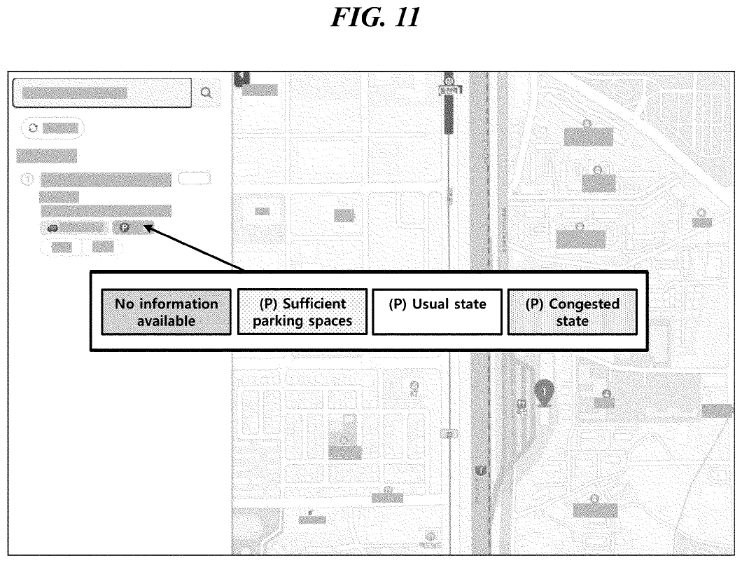

FIG. 11 is a diagram illustrating an example of providing the congestion in the rest area to the drivers according to an embodiment.

Referring to FIG. 11, when a traveling vehicle approaches the rest area, a driver of the vehicle may confirm that the congestion in the rest area is indicated on a display of the navigation system.

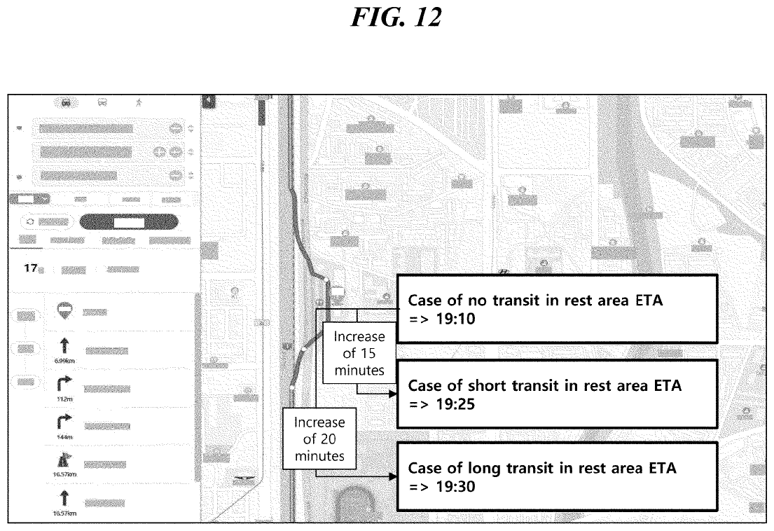

FIG. 12 is a diagram illustrating an example of a state where the estimated time of arrival reflecting rest area staying time information is provided to the drivers according to an embodiment.

Referring to FIG. 12, the driver may confirm that the driver is provided with each information on the expected time of arrival in a case of the “no transit in the rest area”, in a case of the “short transit in the rest area”, and in a case of the “long transit in the rest area”.

According to another embodiment of the present disclosure, there is provided a computer-readable recording medium storing a program that causes a computer to execute a destination arrival time estimation method.

Still another embodiment of the present disclosure may provide a destination arrival time estimation device including a link-set setting circuit configured to set the link-set for the rest area entrance/exit road to obtain the driving information of the vehicles entering and exiting the rest area, a vehicle driving data collection circuit configured to collect the driving data of the vehicles that is generated in units of the link-sets through the global positioning system (GPS), a rest area congestion determination circuit configured to determine the congestion in the rest area, based on the collected driving data of the vehicles, and provide information to the drivers, and an estimated time-of-arrival providing circuit configured to determine the average staying time of the vehicles staying in the rest area, based on the collected driving data of the vehicles, and provide a changed estimated time of arrival (ETA) to the drivers who intend to use the rest area.

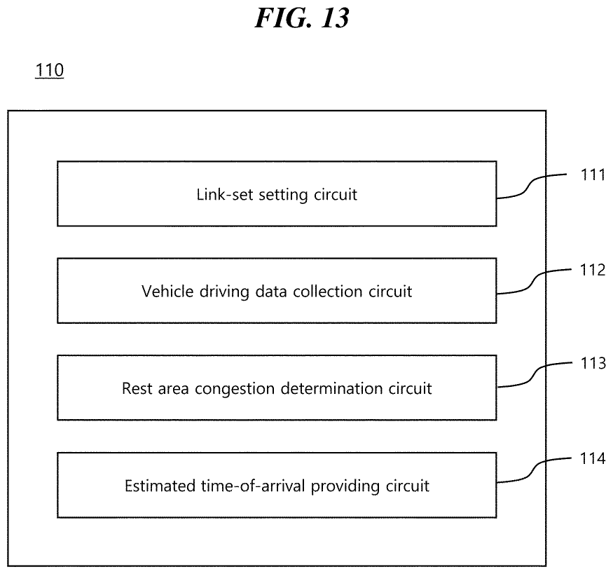

FIG. 13 is a schematic diagram illustrating a destination arrival time estimation device according to an embodiment.

Referring to FIG. 13, the destination arrival time estimation device 110 may include a link-set setting circuit 111, a vehicle driving data collection circuit 112, a rest area congestion determination circuit 113, and an estimated time-of-arrival providing circuit 114.

In the link-set setting circuit 111, the link-set may be set for the exit road or the entrance road of the rest area to obtain the driving information of the vehicles exiting or entering the rest area.

The link is a basic unit configuring a road network, and is a concept essentially used for path finding and provision of the real-time traffic information. The link represents a specific zone, and is generally defined as a short zone having an independent traffic flow, such as a road or a ramp zone between intersections. These links are combined to form the road network. Through the links, navigation systems guide paths, and provide traffic information.

The rest area congestion determination circuit 113 may determine the congestion in the rest area, based on the vehicle driving data collected in this way, and may provide this information to the drivers.

Specifically, the first probe data selection unit may select the first probe data which is the target data that needs to be processed to determine the congestion in the rest area. This first probe data may include link-set attributes of the main line entrance road and the main line exit road, and link-set attributes of the main line entrance road and the connection road exit road.

The entrance link-set probe data aggregation unit may aggregate the probe data matched to the past entrance link-set, in the first probe data, based on the processing time point. In an embodiment, the past entrance link-set means the probe data matched to the entrance link-set for the past 60 minutes, based on the processing time point. However, the past entrance link-set is not limited thereto, and a past time reference may be changed when necessary.

The exit link-set probe data aggregation unit may derive the number of vehicles which do not exit the rest area by aggregating the probe data that is not matched to the current exit link-set, in the first probe data, based on the processing time point.

The rest area congestion determination unit may derive the number of vehicles which do not exit the rest area through this process, and thereafter, may determine the congestion in the rest area can be determined by considering the number of parking spaces in the rest area. For example, the congestion may be determined by using Equation (1) above.

Based on the congestion determined through this step/operation, the congestion information on the rest area may be provided to the drivers.

The congestion provided to the drivers may include four stages of the “no information available”, the “sufficient parking spaces”, the “usual state”, and the “congested state”.

A case of the “no information available’ may mean that there is no information on the rest area, a case of the “sufficient parking spaces” may mean that the congestion is less than 10%, a case of the “usual state” may mean that the congestion is 10% or more and less than 70%, and a case of the “congested state” may mean that the congestion is 70% or more.

The estimated time-of-arrival providing circuit 114 may derive the average staying time of the vehicles staying in the rest area, based on the collected driving data of the vehicles, and may provide a changed estimated time of arrival (ETA) to the drivers who intend to use the rest area.

Specifically, the second probe data selection unit may select the second probe data which is the target data that needs to be processed to provide the estimated time of arrival. This second probe data may include link-set attributes of the main line entrance road and the main line exit road.

The entrance link-set probe data aggregation unit of the estimated time-of-arrival providing circuit 114 may aggregate the probe data matched to the past entrance link-set, in the second probe data, based on the processing time point. In an embodiment, the past entrance link-set means the probe data matched to the entrance link-set for the past 60 minutes, based on the processing time point. However, the past entrance link-set is not limited thereto, and a past time reference may be changed when necessary.

The exit link-set probe data aggregation unit of the estimated time-of-arrival providing circuit 114 may aggregate the probe data matched to the current exit link-set and the probe data that is not match to the current exit link-set, in the second probe data, based on the processing time point.

In the estimated staying time deriving unit, the current estimated staying time may be derived, and may be reflected in the estimated time of arrival, based on the rest area staying time information derived through the probe data matched to the exit link-set and the past staying time information of the vehicle corresponding to the probe data that is not matched to the exit link-set.

In an embodiment, for the vehicles corresponding to the probe data matched to the entrance link-set, the current estimated staying time may be derived by calculating the average staying time for the real-time rest area staying time information of the vehicles which is derived through the probe data matched to the exit link-set and the past rest area staying time information of the vehicles which is derived through the probe data that is not matched to the exit link-set. The navigation systems may thus derive a more accurate staying time, based on the real-time data of the vehicles entering and exiting the rest area and the past data of the vehicles that enter but do not exit the rest area. More specifically, the navigation systems may use the average staying time information of the vehicles staying in the rest area, based on the past driving data of the vehicles that enter but do not exit the rest area.

In addition, the current estimated staying time may include a first estimated staying time reflected in short transit in the rest area, or a second estimated staying time reflected in long transit in the rest area.

In an embodiment, the first estimated staying time may apply staying time data corresponding to a lower rank of 25% of the average staying time data distribution, and the second estimated staying time may apply staying time data corresponding to a lower rank of 75% of the average staying time data distribution.

Specifically, the average staying time data distribution used in the estimated staying time means the distribution of data derived based on the staying time data of the vehicle using the rest area for the past four weeks, based on the processing time point.

The estimated staying time information derived in this way may be provided to the drivers in three stages of “no transit in the rest area”, “short transit in the rest area”, and “long transit in the rest area”.

In a case of the “no transit in the rest area”, the previously provided estimated time of arrival may be maintained, in a case of the “short transit in the rest area”, the first estimated staying time may be reflected in the estimated time of arrival, and in a case of the “long transit tin the rest area”, the second estimated staying time may be reflected in the estimated time of arrival.

The terms “including,” “configuring,” or “having” used herein, unless otherwise specifically described, the terms mean that the corresponding components may be internally interposed. Therefore, it should be construed that other components may be further included rather than excluding the other components. Unless otherwise defined, all terms including technical or scientific terms have meanings the same as meanings commonly understood by those having ordinary skill in the art to which the present disclosure pertains. Commonly used terms, such as terms defined in dictionaries, should be interpreted to be consistent with the meanings in the context of the related art, and should not be interpreted in an idealized or overly formal sense, unless explicitly defined in the present disclosure.

The above description is merely illustrative of the technical idea of the present disclosure, and those having ordinary skill in the art to which the present disclosure pertains may adopt various corrections and modifications without departing from spirit and scope of the present disclosure. Therefore, the embodiments disclosed in the present disclosure are not intended to limit the technical idea of the present disclosure, and are intended to describe the technical idea of the present disclosure. The scope of the technical idea of the present disclosure is not limited by these embodiments. The scope of the present disclosure should be interpreted by the appended claims, and all technical ideas within the scope equivalent thereto should be interpreted as being included in the scope of the present disclosure.

What is claimed is:

1. A destination arrival time estimation method comprising:
a link-set setting step of setting a link-set for a rest area entrance/exit road to obtain driving information of vehicles entering and exiting a rest area;
a vehicle driving data collection step of collecting driving data of the vehicles that is generated in units of link-sets through global positioning system (GPS);
a rest area congestion determination step of determining congestion in the rest area, based on the collected driving data of the vehicles, and providing information on the congestion to drivers; and
an estimated time-of-arrival providing step of determining an average staying time of the drivers staying in the rest area, based on the collected driving data of the vehicles, and providing a changed estimated time of arrival (ETA) to the drivers who intend to use the rest area.

2. The destination arrival time estimation method of claim 1, wherein an attribute of the link-set includes at least one of i) a main line entrance road entering the rest area from a main line, ii) a main line exit road exiting the main line from the rest area, iii) a connection road entrance road entering the rest area from a connection road, or iv) a connection road exit road exiting the connection road from the rest area.

3. The destination arrival time estimation method of claim 2, wherein the connection road includes all roads connected to the rest area other than the main line that is a main road.

4. The destination arrival time estimation method of claim 1, wherein the rest area congestion determination step includes:
a first probe data selection step of selecting first probe data that is a processing target for determining the congestion in the rest area;
an entrance link-set probe data aggregation step of aggregating probe data matched to a past entrance link-set, based on a processing time point in the first probe data;
an exit link-set probe data aggregation step of aggregating probe data that is not matched to a current exit link-set, in the first probe data, based on the processing time point, and determining a number of vehicles that do not exit the rest area; and
a rest area congestion determination step of determining the congestion in the rest area based on a number of parking spaces in the rest area.

5. The destination arrival time estimation method of claim 4, wherein the first probe data includes i) link-set attributes of a main line entrance road and a main line exit road and ii) link-set attributes of the main line entrance road and a connection road exit road.

6. The destination arrival time estimation method of claim 4, wherein, in the entrance link-set probe data aggregation step, the probe data matched to an entrance link-set for past 60 minutes is aggregated, based on the processing time point.

7. The destination arrival time estimation method of claim 4, wherein, in the rest area congestion determination step, the congestion is determined as (the number of vehicles that do not exit the rest area/the number of parking spaces in the rest area)*100.

8. The destination arrival time estimation method of claim 7, wherein, in the rest area congestion determination step, the congestion is determined as one of i) no information available, indicating that indicates that there is no information on the rest area ii) sufficient parking spaces, indicating that the congestion is less than 10% iii) a usual state, indicating that that the congestion is 10% or more and less than 70%, or iv) a congested state, indicating that the congestion is 70% or more.

9. The destination arrival time estimation method of claim 1, wherein the estimated time-of-arrival providing step includes:
a second probe data selection step of selecting second probe data that is a processing target for providing the estimated time of arrival;
an entrance link-set probe data aggregation step of aggregating probe data matched to a past entrance link-set, based on a processing time point in the second probe data;
an exit link-set probe data aggregation step of aggregating probe data matched to a current exit link-set and the probe data that is not matched to the current exit link-set, based on the processing time point in the second probe data; and
an estimated staying time deriving step of determining a current estimated staying time and reflecting the current estimated staying time in the estimated time of arrival, based on rest area staying time information derived from the probe data matched to the exit link-set and past staying time information of a vehicle that corresponds to the probe data that is not matched to the exit link-set.

10. The destination arrival time estimation method of claim 9, wherein the second probe data includes a link-set attribute of a main line entrance road and a main line exit road.

11. The destination arrival time estimation method of claim 9, wherein, in the entrance link-set probe data aggregation step, probe data matched to the entrance link-set for past 60 minutes is aggregated, based on the processing time point.

12. The destination arrival time estimation method of claim 9, wherein, for the vehicle that corresponds to the probe data matched to the entrance link-set, the current estimated staying time is determined by calculating an average staying time for i) real-time rest area staying time information of the vehicles, derived from the probe data matched to the exit link-set, and ii) past rest area staying time information of the vehicles, derived from the probe data that is not matched to the exit link-set.

13. The destination arrival time estimation method of claim 9, wherein the current estimated staying time includes a first estimated staying time reflected in short transit in the rest area or a second estimated staying time reflected in long transit in the rest area.

14. The destination arrival time estimation method of claim 13, wherein:
the first estimated staying time applies staying time data corresponding to bottom 25% of an average staying time data distribution; and
the second estimated staying time applies staying time data corresponding to bottom 75% of the average staying time data distribution.

15. The destination arrival time estimation method of claim 13, wherein the rest area staying time information is provided to a driver as one of i) non-transit in the rest area, ii) short transit in the rest area, or iii) long transit in the rest area, wherein i) in the non-transit in the rest area, a previously provided estimated time of arrival is maintained, ii) in the short transit in the rest area, the first estimated staying time is reflected in the estimated time of arrival, and iii) in the long transit in the rest area, the second estimated staying time is reflected in the estimated time of arrival.

16. A computer-readable recording medium storing a program that, when executed by a processor, causes the processor to:
set a link-set for a rest area entrance/exit road to obtain driving information of vehicles entering and exiting a rest area;
collect driving data of the vehicles that is generated in units of link-sets through global positioning system (GPS);
determine congestion in the rest area, based on the collected driving data of the vehicles, and providing information on the congestion to drivers; and
determine an average staying time of the drivers staying in the rest area, based on the collected driving data of the vehicles, and providing a changed estimated time of arrival (ETA) to the drivers who intend to use the rest area.

17. A destination arrival time estimation device comprising:
a link-set setting circuit configured to set a link set for a rest area entrance/exit road to obtain driving information of vehicles entering and exiting a rest area;
a vehicle driving data collection circuit configured to collect driving data of the vehicles which is generated in units of link-sets through a global positioning system (GPS);
a rest area congestion determination circuit configured to determine congestion in the rest area, based on the collected driving data of the vehicles, and provide information to drivers; and
an estimated time-of-arrival providing circuit configured to determine an average staying time of the vehicles staying in the rest area, based on the collected driving data of the vehicles, and provide a changed estimated time of arrival (ETA) to the drivers who intend to use the rest area.

18. The destination arrival time estimation device of claim 17, wherein the rest area congestion determination circuit includes:
a first probe data selection unit configured to select first probe data that is a processing target for determining the congestion in the rest area;
an entrance link-set probe data aggregation unit configured to aggregate probe data matched to a past entrance link-set, based on a processing time point in the first probe data;
an exit link-set probe data aggregation unit configured to aggregate probe data that is not matched to a current exit link-set, in the first probe data, based on the processing time point, and determine a number of vehicles which do not exit the rest area; and
a rest area congestion determination unit configured to determine the congestion in the rest area based on a number of parking spaces in the rest area.

19. The destination arrival time estimation device of claim 17, wherein the estimated time-of-arrival providing circuit includes:
a second probe data selection unit configured to select second probe data that is a processing target for providing the estimated time of arrival;
an entrance link-set probe data aggregation unit configured to aggregate probe data matched to a past entrance link-set, based on a processing time point in the second probe data
an exit link-set probe data aggregation unit configured to aggregate probe data matched to a current exit link-set and probe data that is not matched to a current exit link-set, based on the processing time point in the second probe data; and
an estimated staying time deriving unit configured to determine a current estimated staying time, based on rest area staying time information derived through the probe data matched to the exit link-set and past staying time information of the vehicles corresponding to the probe data that is not matched to the exit link-set, and reflect the current estimated staying time in the estimated time of arrival.

20. The destination arrival time estimation device of claim 19, wherein the current estimated staying time includes a first estimated staying time reflected in short transit in the rest area or a second estimated staying time reflected long transit in the rest area, wherein i) the first estimated staying time applies staying time data corresponding to bottom 25% of an average staying time data distribution and ii) the second estimated staying time applies staying time data corresponding to bottom 75% of the average staying time data distribution.
